(19) United States
(12) Patent Application Publication
(10) Pub. No.: US 2023/0202060 A1
(43) Pub. Date: Jun. 29, 2023

(54) WEIGHT-ACTUATED OR INERTIALLY-ACTUATED HAND KNIFE

(71) Applicant: Viktor Solomonovich Krasnikov, Moscow (RU)

(72) Inventor: Viktor Solomonovich Krasnikov, Moscow (RU)

(21) Appl. No.: 17/927,879

(22) PCT Filed: Aug. 11, 2020
(86) PCT No.: PCT/RU2020/000399

§ 371 Date: Nov. 26, 2022

(30) Foreign Application Priority Data
Jun. 16, 2020 (RU) 2020119932

(51) Int. Cl. B26B 1/08; B26B 1/10; B26B 5/00

(52) U.S. Cl. CPC B26B 1/08; B26B 1/10; B26B 5/001

(57) ABSTRACT

A weight-actuated or inertially-actuated hand knife includes a handle body with a blade locking button that serves to lock or release a knife blade slidably contained within the handle body. The blade locking button is pressed through a hole in the handle body. One end of the blade locking button rests against a fixed part of a plate that rests on the handle body, and the other end of the button rests against a flexible strip-shaped part of the plate, which is bent towards the blade by default until the button is pressed. The blade includes a stepped end that can abut against the end of the flexible strip-shaped part of the plate. A stop protrudes from the blade and slidably engages a longitudinal cutout in the plate as the blade moves within the handle so as to prevent escape of the blade in both the extended and retracted positions.

### CROSS-REFERENCE TO RELATED APPLICATION

The present US application claims priority from PCT/RU2020/000399, filed Aug. 11, 2020, titled “HAND KNIFE”, which is hereby incorporated by reference in its entirety.

### FIELD OF THE INVENTION

The invention relates generally to cutting tools, and more particularly to hand knives.

### BACKGROUND OF THE INVENTION

Hand knives are known that include a blade mounted inside a handle, and a mechanism for ejecting and returning the blade. The mechanism is in the form of a longitudinally movable bar with a control button and a protrusion in the middle portion of the bar, to which initially stretched counteracting springs are hooked, the other ends of which are fixed to legs of a Π-shaped connecting element acting on the blade held in full excursion positions by locks interacting with stops on the movable bar (published patent application No. 95107721, published Dec. 12, 1996).

Also known are hand knives containing a blade mounted inside a handle, plus an ejecting and returning mechanism. According to this invention, the mechanism for ejecting and returning the blade to the handle is made in the form of a longitudinally movable bar with a control button and a protrusion in the middle part, to which initially partially stretched counteracting springs are hooked, the other ends of which are fixed to legs of a Π-shaped connecting element acting on the blade held in full excursion positions by locks interacting with stops on the movable bar (utility model patent No. 2108906, date of publication: Apr. 20, 1998).

The main disadvantages of these known hand knives are the presence of springs, as well as the method and places of their location. Such a solution complicates the structure and reduces reliability, since the springs are constantly stressed, and such springs wear out quickly when repeatedly stretched while opening and closing the knives.

### SUMMARY OF THE INVENTION

Benefits of the hand knife of the invention include the simplicity and reliability of the structure of the hand knife. The blade of the knife is extended and retracted moving under the action of its own weight or inertia, without being pushed or pulled by a spring.

The above benefits are achieved due to cooperation of a handle body having a hole a therethrough, a blade locking button extending through the hole, and a blade that can slide relative to the handle body and the blade locking button. The blade locking button is made such that it can be pressed through hole a in the handle body.

To lock the blade, a plate is included, the plate being affixed to the handle body so as to trap the blade locking button and the blade between the plate and the handle body. A first end of the blade locking button rests on a fixed part of the plate, and a second end of the blade locking button rests against a flexible movable part of the plate. In its relaxed state, the flexible movable part has the shape of a strip that is made to bend out of the main plane of the plate towards the blade.

The plate and its flexible movable part are made of steel with a thickness of 1-1.5 mm.

The blade includes a stepped end which can abut against the end of the flexible movable part of the plate, the flexible movable part snaping into the stepped end when the blade is fully extended out of the handle body.

In addition, the stop of the blade slides along and within the longitudinal cutout in the plate so as to prevent exiting of the blade from the handle body in both extended and retracted positions.

A handle cover is rigidly mounted to the handle body through holes in the handle cover and in the plate using screws that are configured to screw into threaded holes, thereby securing the plate to the handle body, with the button and blade captured therebetween.

A general aspect of the invention, is a weight-actuated or inertially-actuated hand knife. The hand knife includes: a handle body having a hole therethrough; a blade locking button configured to be pressed via the hole in the handle body, the blade locking button having a first end and a second end; a plate secured to the handle body, the plate having a fixed part and a flexible part, the flexible part initially bent out of a main plane of the plate that includes the fixed part, the flexible part bent towards the handle body; and a blade trapped between the handle body and the plate, the blade locking button also being trapped between the handle body and the plate such that the first end of the blade locking button presses against the fixed part and the second end of the blade locking button presses against the flexible part.

In some embodiments, the hand knife further includes a handle cover configured to cover the plate.

In some embodiments, the handle cover is secured to the handle body via screws that extend through holes in the plate.

In some embodiments, the blade includes a stepped end that is configured to engage with an end of the flexible moving part of the plate when the blade is fully extended from the handle body, thereby locking the blade in a fully extended position when the button is released.

In some embodiments, the blade includes a protruding stop configured to slidably move along a longitudinal cutout in the plate, such that the protruding stop cooperates with the longitudinal cutout in the plate so as to prevent the blade from escaping from the handle body when the blade is in either the fully extended or fully retracted positions.

In some embodiments, the plate having the fixed part and the flexible part is made of flexible steel with a thickness of 1.0-1.5 mm.

### BRIEF DESCRIPTION OF THE DRAWING

Many additional features and advantages will become apparent to those skilled in the art upon reading the following detailed description, when considered in conjunction with the accompanying drawings, wherein:

FIG. 1 shows an exploded view of an embodiment of the weight-actuated or inertially-actuated hand knife.

### DETAILED DESCRIPTION

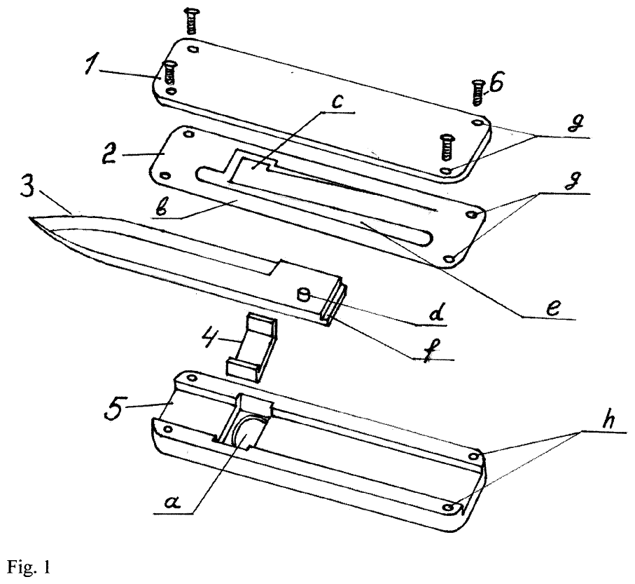

Referring to FIG. 1, an embodiment of the hand knife is shown in a disassembled state, wherein:
1 is a handle cover;
2 is a plate having flexible strip;
3 is a blade;
4 is a button for locking the blade in extended and retracted positions;
5 is a handle body;
6 is a screw; and,
a is a hole through the handle body 5;
b is a stationary part of the plate 2;
c is a flexible movable part of the plate 2, which is made to be initially bent away from the main plane of the plate 2;
d is a protruding stop on the blade 3;
e is a longitudinal cutout in the plate. 2;
f is a stepped end of the blade 3;
g are unthreaded holes; and
h are threaded holes in the handle body 5.

The knife works as follows:

In the fully retracted state, the flexible movable part c of the plate 2 presses against the blade 3, thereby preventing the blade 3 from moving within the handle body 5, even if the knife is tilted or rapidly moved in an arc. The protruding stop d on the blade 3 is located at the most proximal end of the longitudinal cutout e in the plate 2.

To release the blade 3 in the fully retracted state from the handle body 5, one holds the knife with the blade 3 directed downward, and then one presses the blade locking button 4 through the hole a in the handle body 5. One end of the button 4 thereby presses against the fixed part b of the plate 2, and the other end of the button 4 presses against the movable part c. Consequently, the movable elastic part c of the plate 2 stops pressing against the blade 3, thereby reducing frictional pressure on the blade 3, which then falls down within the handle body 5 under the action of its own weight (weight actuation) until the blade 3 reaches maximum extension.

When the blade 3 reaches maximum extension, the stop d (protrusion) on the blade 3 reaches the end of the longitudinal cutout e, whereupon the blade 3 stops moving within the handle body 5, and if the button 4 is released, the flexible movable part c falls onto the step f at the end of the blade 3, thereby locking the blade 3 in the fully extended state.

The blade 3 includes a stepped end f which can abut against the end of the flexible movable part c of the plate 2, the flexible movable part c snaping into the stepped end f when the blade 3 is fully extended out of the handle body 5. The stepped end f engages with the end of the flexible moving part c of the plate 2 when the blade 3 is fully extended from the handle body 5, thereby locking the blade 3 in a fully extended position when the button 4 is released.

Another way that the blade 3 can be released into the fully extended state is by pressing the button 4, thereby reducing pressure and resulting friction due to the flexible movable part c being pushed off of the blade 3, and simultaneously abruptly moving the hand knife forward and then rapidly pulling the handle body 5 backward (inertial actuation). The blade 3 of the hand knife will surge out from the handle body 5 due to the effect of the forward momentum of the blade 3 due to the abrupt reversal of motion of the entire hand knife.

To retract the blade 3 back into the handle body 5, orient the hand knife with the blade 3 pointing up, and then press the blade locking button 4 through the hole in the handle body 5. The end of the flexible part c of the plate 2 comes off the blade step f, and the blade 3 can then fall into the handle body 5 under the action of its own weight. When the button 4 is then released, the flexible part c of the plate 2 is again allowed to press against the blade 3, and the static friction thereby created ensures that the blade 3 remains securely held within the handle body 5.

Thus, a user of the hand knife of the invention can retract and extend the blade 3 by exploiting the weight or momentum of the blade 3, without the use of additional forces or springs.

The hand knife exhibits structural simplicity and reliability. For example, the structure of the hand knife allows for easily disassembly and assembly (such as for repair or cleaning). Also, the reliability of the structure is achieved due to the fact that, for example, the blade 3 cannot be pushed into the handle body 5, nor can the blade fall out of the handle body 5 if the button 4 is not pressed.

Other modifications and implementations will occur to those skilled in the art without departing from the spirit and the scope of the invention as claimed. Accordingly, the above description is not intended to limit the invention, except as indicated in the following claims.

What is claimed is:

1. A weight-actuated or inertially-actuated hand knife, the hand knife comprising:
a handle body having a hole therethrough;
a blade locking button configured to be pressed via the hole in the handle body, the blade locking button having a first end and a second end;
a plate secured to the handle body, the plate having a fixed part and a flexible part, the flexible part initially bent out of a main plane of the plate that includes the fixed part, the flexible part bent towards the handle body; and
a blade trapped between the handle body and the plate, the blade locking button also being trapped between the handle body and the plate such that the first end of the blade locking button presses against the fixed part and the second end of the blade locking button presses against the flexible part.

2. The hand knife of claim 1, further comprising:
a handle cover configured to cover the plate.

3. The hand knife of claim 2, wherein the handle cover is secured to the handle body via screws that extend through holes in the plate.

4. The hand knife of claim 1, wherein the blade includes a stepped end that is configured to engage with an end of the flexible moving part of the plate when the blade is fully extended from the handle body, thereby locking the blade in a fully extended position when the button is released.

5. The hand knife of claim 1, wherein blade includes a protruding stop configured to slidably move along a longitudinal cutout in the plate, such that the protruding stop cooperates with the longitudinal cutout in the plate so as to prevent the blade from escaping from the handle body when the blade is in either the fully extended or fully retracted positions.

6. The hand knife of claim 1, wherein the plate having the fixed part and the flexible part is made of flexible steel with a thickness of 1.0-1.5 mm.
